(19) United States
(12) Patent Application Publication
(10) Pub. No.: US 2025/0274730 A1
(43) Pub. Date: Aug. 28, 2025

(54) SERVER, COMMUNICATION SYSTEM, AND VEHICLE

(71) Applicant: TOYOTA JIDOSHA KABUSHIKI KAISHA, Toyota-shi (JP)

(72) Inventors: Kanade KURIYAMA, Toyota-shi (JP); Masataka OKUDA, Toyota-shi (JP); Kaoru YOSHIDA, Nisshin-shi (JP); Toshiki SHINOHARA, Toyota-shi (JP); Masatoshi KAKUTANI, Miyoshi-shi (JP)

(73) Assignee: TOYOTA JIDOSHA KABUSHIKI KAISHA, Toyota-shi (JP)

(21) Appl. No.: 19/062,119

(22) Filed: Feb. 25, 2025

(30) Foreign Application Priority Data
Feb. 28, 2024 (JP) 2024-028599

(51) Int. Cl. H04W 4/46; H04L 67/12; H04W 28/14

(52) U.S. Cl. CPC H04W 4/46; H04L 67/12; H04W 28/14

(57) ABSTRACT

A server is configured to communicate with a first vehicle and a second vehicle. When determination is made that a communication quality with the first vehicle is lower than a predetermined quality, the server is configured to transmit, to the second vehicle, information indicating a request of transmitting vehicle information of the first vehicle from the second vehicle.

### CROSS-REFERENCE TO RELATED APPLICATION

This application claims priority to Japanese Patent Application No. 2024-028599 filed on Feb. 28, 2024. The disclosure of the above-identified application, including the specification, drawings, and claims, is incorporated by reference herein in its entirety.

### BACKGROUND

### 1. Technical Field

The disclosure relates to a server, a communication system, and a vehicle.

### 2. Description of Related Art

Japanese Unexamined Patent Application Publication No. 2016-212610 (JP 2016-212610 A) describes a system including: a server; a first vehicle that is able to communicate with the server; and a second vehicle that is unable to communicate with the server. The first vehicle transmits vehicle information of the first vehicle and vehicle information of the second vehicle to the server.

### SUMMARY

In systems as described in JP 2016-212610 A, there are some cases where the second vehicle is a vehicle that is able to communicate with the server. In such a case, the server can be delayed in acquiring the vehicle information of the first vehicle, depending on a communication state of the first vehicle.

One aspect of the present disclosure is a server configured to communicate with a first vehicle and a second vehicle, wherein when determination is made that a communication quality with the first vehicle is lower than a predetermined quality, the server is configured to transmit, to the second vehicle, information indicating a request of transmitting vehicle information of the first vehicle from the second vehicle.

One aspect of the present disclosure is a communication method that is performed by a server configured to communicate with a first vehicle and a second vehicle, the communication method including, when determination is made that a communication quality with the first vehicle is lower than a predetermined quality, transmitting, to the second vehicle, information indicating a request that vehicle information of the first vehicle be transmitted from the second vehicle.

One aspect of the present disclosure is a communication program that is executed by a server that is able to communicate with a first vehicle and a second vehicle, the communication program causing the server to, when determination is made that a communication quality with the first vehicle is lower than a predetermined quality, transmit, to the second vehicle, information indicating a request of transmitting vehicle information of the first vehicle from the second vehicle.

One aspect of the present disclosure is a communication system including: a first vehicle; a second vehicle; and a server configured to communicate with the first vehicle and the second vehicle, wherein when determination is made that a communication quality with the first vehicle is lower than a predetermined quality, the server is configured to transmit, to the second vehicle, information indicating a request of transmitting vehicle information of the first vehicle from the second vehicle, and, when the information indicating the request of transmitting vehicle information of the first vehicle from the second vehicle is received, the second vehicle is configured to transmit the vehicle information of the first vehicle to the server from the second vehicle. According to each configuration described above, it is possible to reduce the likelihood of the server being delayed in acquiring the vehicle information of the first vehicle due to deterioration of the communication quality with the first vehicle.

One aspect of the present disclosure is a vehicle configured to: when determination is made, by a server that is configured to communicate with a vehicle, that communication quality of a target vehicle is lower than a predetermined quality, receive information indicating a request of collecting and transmitting vehicle information on the target vehicle to the server; and when the information indicating the request of transmitting the vehicle information of the target vehicle to the server is received, transmit the vehicle information of the target vehicle to the server.

According to such a configuration, it is possible to reduce the likelihood of the server being delayed in acquiring the vehicle information of the target vehicle due to deterioration of the communication quality of the target vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a communication system;

FIG. 2 is a flowchart showing a series of processes of generating forecast information in a first embodiment;

FIG. 3 is a flowchart showing a series of processes of determining a vehicle group in the first embodiment;

FIG. 4 is a flowchart showing a series of processes including making a request to collect and transmit vehicle information in the first embodiment;

FIG. 5 is a sequence chart describing a flow of information when a state is turned from an individual transmission state into a collection-transmission state in the first embodiment;

FIG. 6 is a flowchart showing a series of processes including making a request to individually transmit vehicle information in the first embodiment;

FIG. 7 is a sequence chart describing a flow of information when a state is turned from the collection-transmission state into the individual transmission state in the first embodiment;

FIG. 8 is a flowchart showing a series of processes including making a request to collect and transmit vehicle information in a second embodiment;

FIG. 9 is a sequence chart describing a flow of information when a state is turned from a state of individually transmitting first vehicle information into a state of collecting and transmitting first vehicle information in the second embodiment;

FIG. 10 is a flowchart showing a series of processes including making a request to individually transmit first vehicle information in the second embodiment;

FIG. 11 is a sequence chart describing a flow of information when a state is turned from a state of collecting and transmitting first vehicle information into a state of individually transmitting first vehicle information in the second embodiment; and

FIG. 12 is a flowchart showing a series of processes including making a request to collect and transmit vehicle information in a third embodiment.

### DETAILED DESCRIPTION OF EMBODIMENTS

### First Embodiment

Hereinafter, a first embodiment of a server, a communication system, a communication method, and a communication program is described.

### Outline of Communication System

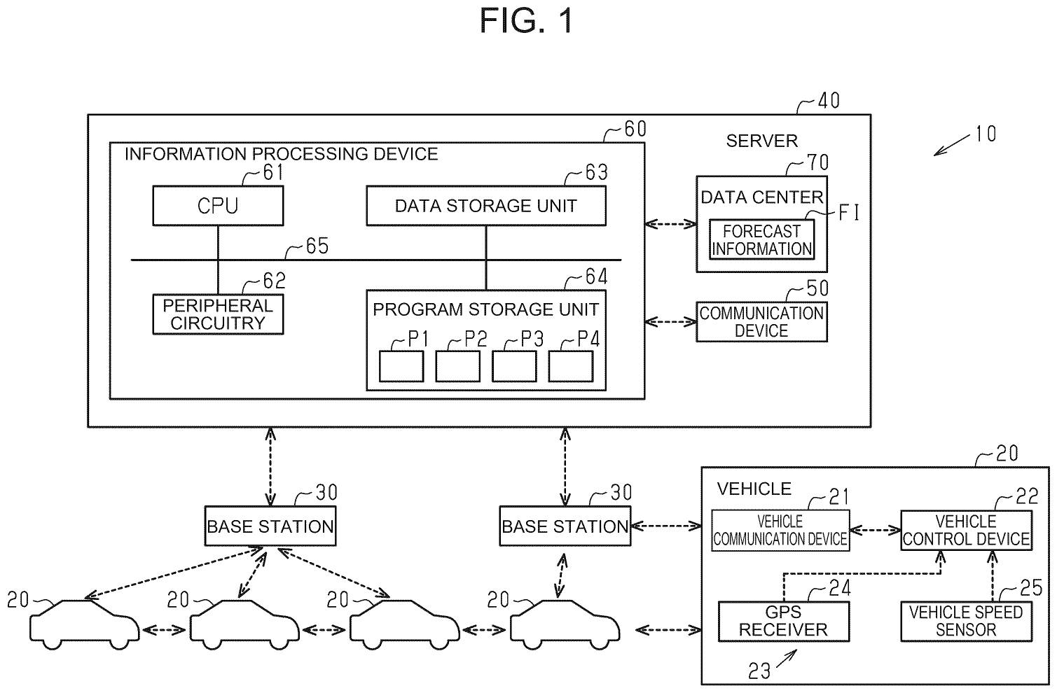

As shown in FIG. 1, a communication system 10 includes a plurality of vehicles 20, a plurality of base stations 30, and a server 40.

Each vehicle 20 includes a vehicle communication device 21, a vehicle control device 22, and a plurality of information acquisition devices 23. The vehicle communication device 21 communicates with the server 40 via a base station 30 through wireless communication. The vehicle control device 22 is a device intended to control the vehicle 20. The vehicle control device 22 outputs, to the vehicle communication device 21, information to be transmitted to the server 40. The vehicle control device 22 acquires, from the vehicle communication device 21, information from the server 40 received by the vehicle communication device 21.

The plurality of information acquisition devices 23 acquires various information on the vehicle 20. The plurality of information acquisition devices 23 includes, for example, a GPS receiver 24 and a vehicle speed sensor 25. The GPS receiver 24 receives, from a GPS satellite, position information indicating the current position of the vehicle 20. The position information is latitude and longitude coordinate values. The vehicle speed sensor 25 acquires the traveling speed of the vehicle 20 as a vehicle speed. Each information acquisition device 23 outputs the acquired information on the vehicle 20 to the vehicle control device 22.

The vehicle control device 22 acquires, as vehicle information VI, the various information on the vehicle 20 acquired from the plurality of information acquisition devices 23, identification information indicating the vehicle 20, and a time of acquisition of the various information. The vehicle control device 22 outputs the vehicle information VI to the vehicle communication device 21. The vehicle communication device 21 transmits the vehicle information VI to the server 40 via the base station 30.

The vehicle control device 22 calculates a value indicating a communication quality in transmitting the vehicle information VI to the server 40. The value indicating the communication quality is, for example, a transmission speed. The value indicating the communication quality in transmitting the vehicle information VI is transmitted to the server 40 concurrently with the transmission of the vehicle information VI.

Note that in FIG. 1, one vehicle 20 of the plurality of vehicles 20 is depicted in detail, and depiction of the details of the other vehicles 20 is omitted. The plurality of vehicles 20 can communicate information with each other under a predetermined condition. The predetermined condition is, for example, a case where vehicles 20 within a preset distance transmit a preset type of information by using a preset frequency band. In other words, the plurality of vehicles 20 is capable of so-called vehicle-to-vehicle communication.

Each base station 30 constructs a network over which wireless communication with a vehicle 20 and the server 40 is performed. The plurality of base stations 30 constructs networks, respectively. Each vehicle 20 selects one base station 30 15 from among the plurality of base stations 30 and performs wireless communication with the server 40 by using a network constructed by the selected base station 30. Note that when a vehicle 20 performs vehicle-to-vehicle communication with another vehicle 20, the communication is performed without going through any base station 30.

The server 40 is configured to be able to communicate with all base stations 30 of the plurality of base stations 30. Accordingly, the server 40 can communicate with the plurality of vehicles 20. The server 40 includes a communication device 50, an information processing device 60, and a data center 70.

The communication device 50 performs communication with each of the plurality of vehicles 20 via a base station 30. The communication device 50 receives vehicle information VI and a value indicating a communication quality transmitted from a vehicle 20. The communication device 50 outputs the received vehicle information VI and value indicating the communication quality to the information processing device 60. Moreover, the communication device 50 transmits information acquired from the information processing device 60 to a vehicle 20 via a base station 30.

The information processing device 60 includes a CPU 61, which is an execution device, peripheral circuitry 62, a data storage unit 63, a program storage unit 64, and a bus 65. The bus 65 connects the CPU 61, the peripheral circuitry 62, the data storage unit 63, and the program storage unit 64 in such a manner that the units and the like can communicate with each other. The peripheral circuitry 62 includes a circuit that generates a clock signal for defining internal operation, a power supply circuit, a reset circuit, and the like. The data storage unit 63 stores data generated as a result of execution by the CPU 61. The program storage unit 64 stores a program to be executed by the CPU 61. The CPU 61 performs information processing by executing various programs stored in the program storage unit 64. The CPU 61 stores, in the data storage unit 63, data generated as a result of performing the information processing. The program storage unit 64 stores a generation program P1 for generating forecast information FI, a determination program P2 for determining a vehicle group, a collection program P3 for collecting vehicle information VI, and a division program P4 for dividing vehicle information VI. The CPU 61 outputs information to the data center 70 after performing the information processing.

The data center 70 stores forecast information FI. The forecast information FI is generated based on vehicle information VI on a plurality of vehicles 20. The forecast information FI is information that includes a plurality of pieces of vehicle information VI in a predetermined area after the time of acquisition of the original vehicle information VI. The predetermined area may be, for example, a range including one country, a range including only one or some regions of one country, or a range including the whole world. In other words, the forecast information FI is a so-called digital twin. Specifically, the data center 70 stores time-series data of forecast information FI generated by the information processing device 60. In other words, the data center 70 acquires forecast information FI generated by the information processing device 60 a plurality of times as time passes. Thus, the data center 70 stores the time-series data of the forecast information FI.

### Generation of Forecast Information

Next, the generation of forecast information FI performed by the information processing device 60 is described.

The CPU 61 generates forecast information FI repeatedly by executing the generation program P1 for generating forecast information FI in each preset predetermined period. The predetermined period is set to, for example, one minute.

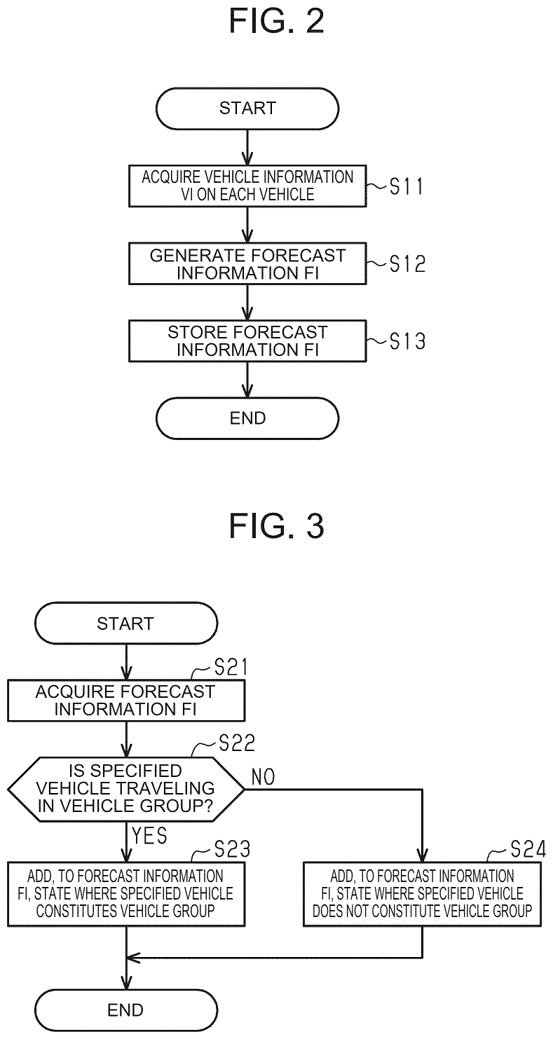

As shown in FIG. 2, when execution of the generation program P1 for generating forecast information FI is started, the CPU 61 first performs a process in step S11.

In step S11, the CPU 61 acquires vehicle information VI on each vehicle 20 in the communication system 10. When a plurality of pieces of vehicle information VI is acquired, the CPU 61 acquires the vehicle information VI on each vehicle 20, based on identification information on the vehicle 20 included in the vehicle information VI. Thereafter, the CPU 61 moves the process to step S12.

In step S12, the CPU 61 generates forecast information FI, based on the acquired plurality of pieces of vehicle information VI. Specifically, the CPU 61 generates the forecast information FI by synchronizing the vehicle information VI on each vehicle 20 by performing processes described below. First, with regard to the acquired plurality of pieces of vehicle information VI, the CPU 61 refers to information indicating the time of acquisition. Next, by using, for a reference time, the time of acquisition of the vehicle information VI that has the latest time of acquisition, the CPU 61 corrects the other vehicle information VI by a difference between the times of acquisition, and thereby forecasts vehicle information VI at the reference time. For example, the CPU 61 performs the correction based on the past vehicle information VI, such as vehicle speeds and the like. The CPU 61 generates the forecast vehicle information VI as forecast information FI. Thus, the CPU 61 acquires, as forecast information FI, the vehicle information VI on the plurality of vehicles 20 synchronized with the current time. Thereafter, the CPU 61 moves the process to step S13.

In step S13, the CPU 61 stores the generated forecast information FI in the data center 70. Thereafter, the CPU 61 terminates the series of processes. Thus, the data center 70 stores the acquired forecast information FI. The CPU 61 repeats executing the generation program P1 for generating forecast information FI, whereby the data center 70 acquires and stores forecast information FI in each predetermined period. Accordingly, the data center 70 is in a state of storing a time-series data of the forecast information FI.

### Determination of Vehicle Group

Next, determination of a vehicle group performed by the information processing device 60 is described.

The CPU 61 repeats the determination program P2 for determining a vehicle group in each preset predetermined period. The predetermined period is set to, for example, one minute. Thus, the CPU 61 determines whether or not a specified vehicle 20 among the plurality of vehicles 20 constitutes a vehicle group with another vehicle 20 that is different from the specified vehicle 20 among the plurality of vehicles 20, and is traveling in the vehicle group.

As shown in FIG. 3, when execution of the determination program P2 for determining a vehicle group is started, the CPU 61 first starts a process in step S21.

In step S21, the CPU 61 acquires data for a past predetermined period in the time-series data of the forecast information FI in the data center 70. The past predetermined period is, for example, ten minutes. Thereafter, the CPU 61 moves the process to step S22.

In step S22, the CPU 61 determines, based on the time-series data of the forecast information FI for the past predetermined period acquired in step S21, whether or not a vehicle 20 that is a specified target vehicle is traveling in a vehicle group including another vehicle 20. In the present embodiment, the CPU 61 determines whether or not the specified vehicle 20 is traveling in a similar manner to another vehicle 20 for a predetermined period within a predetermined range, by comparing the forecast information FI on the plurality of vehicles 20.

Specifically, first, the CPU 61 selects another vehicle 20 that indicates a position within the predetermined range, based on position information included in the latest forecast information FI on the specified vehicle 20. Next, at each reference time, the CPU 61 compares the position information on the specified vehicle 20 with position information on the selected other vehicle 20 and selects the other vehicle 20 when the other vehicle 20 exists within the predetermined range from the position of the specified vehicle 20 in the past predetermined period. When there are one or more other vehicles 20 that can be selected, the CPU 61 determines that the specified vehicle 20 constitutes a vehicle group with the one or more other vehicles 20, and that each vehicle 20 included in the vehicle group is traveling. When there is no other vehicle 20 that can be selected, the CPU 61 determines that the specified vehicle 20 does not constitute a vehicle group with another vehicle 20. When the position of the specified vehicle 20 did not change in the past predetermined period, it is determined that the vehicle group is not traveling.

When the CPU 61 determines that the specified vehicle 20 is traveling in a vehicle group including another vehicle 20 (S22: YES), the CPU 61 moves the process to step S23. In step S23, the CPU 61 adds, to the forecast information FI, information indicating that the specified vehicle 20 is in a state of constituting a vehicle group with another vehicle 20. For example, in the forecast information FI, the CPU 61 assigns a label for identifying the vehicle group to the vehicle group including the specified vehicle 20, and also sets, on the vehicles 20 included in the vehicle group to which the label is assigned, a flag indicating that the vehicles 20 are included in the vehicle group identified with the label. Thereafter, the CPU 61 terminates the series of processes.

When the CPU 61 determines that the specified vehicle 20 is not traveling in a vehicle group including another vehicle 20 (S22: NO), the CPU 61 moves the process to step S24. In step S24, the CPU 61 adds, to the forecast information FI, information indicating that the specified vehicle 20 is in a state of not constituting a vehicle group with another vehicle 20. For example, the CPU 61 clears the flag. Thereafter, the CPU 61 terminates the series of processes.

Note that the information processing device 60 can identify a vehicle 20 that is traveling in one vehicle group by executing the determination program P2 for determining a vehicle group with regard to each vehicle 20. Moreover, a plurality of vehicles 20 included in one vehicle group can be identified by attaching a result of the selection of another vehicle 20 in the vehicle group.

### Determination, by Server, of Whether or Not to Perform Collection-Transmission When Individual Transmission Is Being Performed

Next, a description is given of processes performed by the information processing device 60 when vehicle information VI is collected and transmitted. Here, as an example, a state is described in which one vehicle group includes five vehicles 20 among the plurality of vehicles 20. Note that the five vehicles 20 include a first vehicle, a second vehicle, and a third vehicle, which will be described later.

When each vehicle 20 in the vehicle group individually transmits vehicle information VI to the server 40, the CPU 61 executes the collection program P3 for collecting vehicle information VI in each preset predetermined period. The predetermined period is, for example, one minute. Specifically, when the flag indicating that a vehicle group is constituted is set in the forecast information FI, the CPU 61 determines that vehicles 20 with the flag set thereon constitute one vehicle group. When vehicle information VI is received individually from all the vehicles 20 constituting the one vehicle group, the CPU 61 determines that each vehicle 20 in the vehicle group individually transmits vehicle information VI to the server 40. Note that the CPU 61 determines whether or not vehicle information VI is received individually, based on, for example, whether or not all the times of reception coincide.

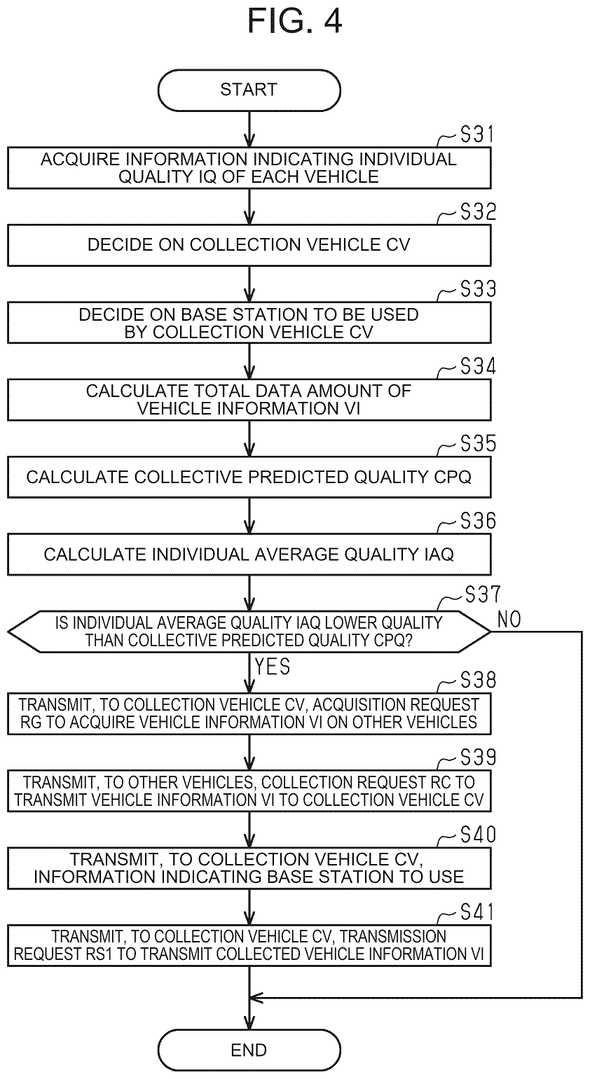

As shown in FIG. 4, when the CPU 61 starts executing the collection program P3 for collecting vehicle information VI, the CPU 61 first performs a process in step S31. In step S31, the CPU 61 acquires, from each vehicle 20 included in the vehicle group, a value indicating a communication quality in individually transmitting vehicle information VI, as information indicating an individual quality IQ. The individual quality IQ is a communication quality when the plurality of vehicles 20 individually transmits vehicle information VI. For example, the individual quality IQ is a transmission speed. Thereafter, the CPU 61 moves the process to step S32.

In step S32, the CPU 61 decides on a collection vehicle CV from among the five vehicles 20. The collection vehicle CV is a vehicle 20 that collects and transmits, to the server 40, vehicle information VI on the five vehicles 20 included in one vehicle group. The CPU 61 decides on, as the collection vehicle CV, a vehicle 20 with the highest individual quality IQ among the individual qualities IQ of the vehicles 20 acquired through the process in step S31. Note that of the five vehicles 20, a vehicle 20 with the lowest individual quality

IQ is the first vehicle and a target vehicle. Moreover, of the five vehicles 20, the collection vehicle CV is the second vehicle, and one vehicle 20 of the remaining three vehicles 20 is the third vehicle. Thereafter, the CPU 61 moves the process to step S33.

In step S33, the CPU 61 decides on a base station 30 to be used by the collection vehicle CV. As the base station 30 to be used by the collection vehicle CV, the CPU 61 decides on a base station 30, among the plurality of base stations 30, that is the closest to a position indicated by position information included in the latest forecast information FI on the collection vehicle CV. Thereafter, the CPU 61 moves the process to step S34.

In step S34, the CPU 61 calculates a total data amount of the vehicle information VI on all the vehicles 20 included in the vehicle group. The total data amount is, for example, a data size. Specifically, the CPU 61 calculates the total data amount of the vehicle information VI on all the vehicles 20 included in the vehicle group by multiplying a preset data amount of vehicle information VI by the number of the vehicles 20 included in the vehicle group. Thereafter, the CPU 61 moves the process to step S35.

In step S35, the CPU 61 predicts, as a collective predicted quality CPQ, a communication quality expected when the collection vehicle CV collects and transmits the vehicle information VI on all the vehicles 20 included in the vehicle group to the server 40. Specifically, the CPU 61 assumes a case where the collection vehicle CV transmits, by using the base station 30 decided in step S33, the total data amount of the vehicle information VI calculated in step S34. The CPU 61 calculates a transmission speed expected when the total data amount is communicated by using the decided base station 30. The CPU 61 calculates the calculated transmission speed as a value indicating the collective predicted quality CPQ. Thereafter, the CPU 61 moves the process to step S36.

In step S36, the CPU 61 calculates, as an individual average quality IAQ, an average quality of the individual qualities IQ, each indicated by the information indicating the individual quality IQ acquired in step S31. Specifically, as a value indicating the individual average quality IAQ, the CPU 61 calculates an average value of the transmission speeds in individuation transmission, which are the individual qualities IQ. In other words, in step S36, the CPU 61 calculates the individual average quality IAQ with regard to the plurality of vehicles 20 including the first vehicle, the second vehicle, and the third vehicle. Thereafter, the CPU 61 moves the process to step S37.

In step S37, the CPU 61 determines whether or not the individual average quality IAQ is a lower quality than the collective predicted quality CPQ. Specifically, the CPU 61 compares the transmission speed calculated as the individual average quality IAQ with the transmission speed calculated as the collective predicted quality CPQ. When the transmission speed calculated as the individual average quality IAQ is less than the transmission speed calculated as the collective predicted quality CPQ, the CPU 61 determines that the individual average quality IAQ is a lower quality than the collective predicted quality CPQ. When the transmission speed calculated as the individual average quality IAQ is equal to or more than the transmission speed calculated as the collective predicted quality CPQ, the CPU 61 determines that the individual average quality IAQ is not a lower quality than the collective predicted quality CPQ. Note that the collective predicted quality CPQ is a first predetermined quality in the first embodiment.

Note that in the first embodiment, when it is determined that the individual average quality IAQ is a lower quality than the collective predicted quality CPQ, it can be naturally determined that the individual quality IQ of a vehicle 20 that is the first vehicle with the lowest individual quality IQ is a lower quality than the collective predicted quality CPQ. On the other hand, when it is determined that the individual average quality IAQ is a lower quality than the collective predicted quality CPQ, there can be some cases where the individual quality IQ of the third vehicle that is different from the first vehicle and the second vehicle is not a lower quality than the collective predicted quality CPQ.

When the CPU 61 determines that the individual average quality IAQ is a lower quality than the collective predicted quality CPQ (S37: YES), the CPU 61 moves the process to step S38. In step S38, the CPU 61 transmits, to the collection vehicle CV, an acquisition request RG to acquire vehicle information VI on the other vehicles 20. Thereafter, the CPU 61 moves the process to step S39.

In step S39, the CPU 61 transmits, to the other vehicles 20 in the vehicle group, a collection request RC to transmit vehicle information VI to the collection vehicle CV. Note that each vehicle 20 that has received the collection request RC discontinues individually transmitting vehicle information VI to the server 40 without going through the collection vehicle CV. Thereafter, the CPU 61 moves the process to step S40.

In step S40, the CPU 61 transmits, to the collection vehicle CV, information indicating the base station 30 to use that is decided in step S33. Thereafter, the CPU 61 moves the process to step S41.

In step S41, the CPU 61 transmits, to the collection vehicle CV, a transmission request RS1 to transmit collected vehicle information VI. In other words, the CPU 61 transmits, to the second vehicle that is the collection vehicle CV, a request to collect and transmit vehicle information VI on all the vehicles 20 that constitute the vehicle group including the first vehicle. Note that the collection vehicle CV that has received the transmission request collect and transmits, to the server 40, vehicle information VI on the plurality of vehicles 20 constituting the vehicle group. Moreover, as described above, in the first embodiment, even if the individual quality IQ of the third vehicle is higher than the collective predicted quality CPQ, the transmission request RS1 to transmit vehicle information VI on the third vehicle to the collection vehicle CV is transmitted. Thereafter, the CPU 61 terminates the series of processes.

When the CPU 61 determines that the individual average quality IAQ is not a lower quality than the collective predicted quality CPQ (S37: NO), the CPU 61 terminates the series of processes. In other words, in such a case, the CPU 61 terminates the series of processes, leaving the state as it is in which vehicle information VI on all the vehicles 20 constituting the vehicle group is not collected to the collection vehicle CV and vehicle information VI is transmitted individually from each vehicle 20.

Flow of Information When State Is Turned from Individual Transmission State into Collection-Transmission State

Next, a description is given of a flow of information in the communication system 10 when a state is turned from a state where the plurality of vehicles 20 individually transmits vehicle information VI, into a state where the collection vehicle CV collects and transmits vehicle information VI. Note that in the following description of a flow of information, vehicle information VI and each request are described, and a description of information added to vehicle information VI and information indicating a base station is omitted.

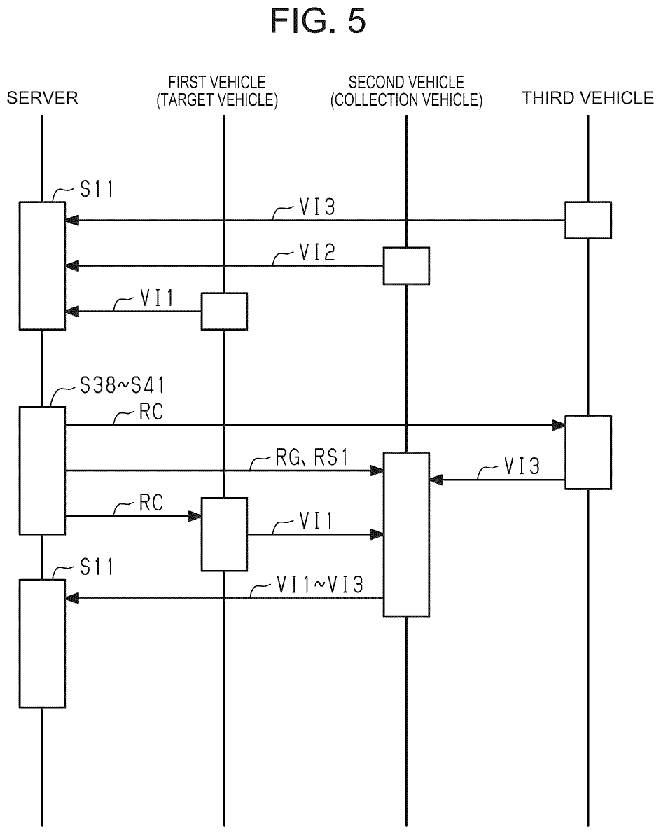

As shown in FIG. 5, the plurality of vehicles 20 individually transmits vehicle information VI to the server 40. The first vehicle, which is the target vehicle included in the plurality of vehicles 20, transmits first vehicle information VII, which is the vehicle information VI on the first vehicle, to the server 40. The second vehicle, which is the collection vehicle included in the plurality of vehicles 20, transmits second vehicle information VI2, which is the vehicle information VI on the second vehicle, to the server 40. The third vehicle included in the plurality of vehicles 20 transmits third vehicle information VI3, which is the vehicle information VI on the third vehicle, to the server 40. The server 40 acquires the first vehicle information VI1, the second vehicle information VI2, and the third vehicle information VI3 through the process in step S11. Note that the following description of a flow of information is given, assuming that the five vehicles 20 included in the plurality of vehicles 20 include a first vehicle, a second vehicle, and three third vehicles. Moreover, in the drawings, only one third vehicle is depicted.

Next, when the server 40 makes an affirmative determination in step S37 by executing the collection program P3 for collecting vehicle information VI, the server 40 performs processes in steps S38 to S41. Thus, the server 40 transmits a collection request RC to the third vehicle. The third vehicle that has received the collection request RC transmits third vehicle information VI3, which is the own vehicle information VI, to the second vehicle. Moreover, the server 40 transmits a collection request RC to the first vehicle. The first vehicle that has received the collection request RC transmits first vehicle information VI1, which is the own vehicle information VI, to the second vehicle. Further, the server 40 transmits an acquisition request RG and a transmission request RS1 to the second vehicle. The second vehicle that has received the acquisition request RG and the transmission request RS1 collects and transmits the first vehicle information VI1, the second vehicle information VI2, and the third vehicle information VI3 to the server 40. The server 40 acquires the first vehicle information VI1, the second vehicle information VI2, and the third vehicle information VI3 from the second vehicle through the process in step S11. In other words, through the transmission and reception of such information in the communication system 10, the collection vehicle CV receives a transmission request RS1 to transmit first vehicle information VI1 when it is determined by the server 40 that the communication quality of the first vehicle, which is the target vehicle, is lower than a first predetermined quality. When the transmission request RS1 is received, the collection vehicle CV transmits first vehicle information VI1 to the server 40.

### Determination of Whether or Not to Perform Individual Transmission When Collection-Transmission Is Being Performed

Next, a description is given of processes performed by the information processing device 60 when vehicle information VI is individually transmitted. When the collection vehicle CV, of the vehicles 20 constituting the vehicle group, collects and transmits vehicle information VI to the server 40, the CPU 61 executes the division program P4 for dividing vehicle information VI in each preset predetermined period. The predetermined period is, for example, one minute. Specifically, when the flag indicating that a vehicle group is constituted is set in the forecast information FI, the CPU 61 determines that vehicles 20 with the flag set thereon constitute one vehicle group. Moreover, when vehicle information VI is collectively received from the collection vehicle CV of the plurality of vehicles 20 constituting the one vehicle group, the CPU 61 determines that the collection vehicle CV is collecting and transmitting vehicle information VI to the server 40.

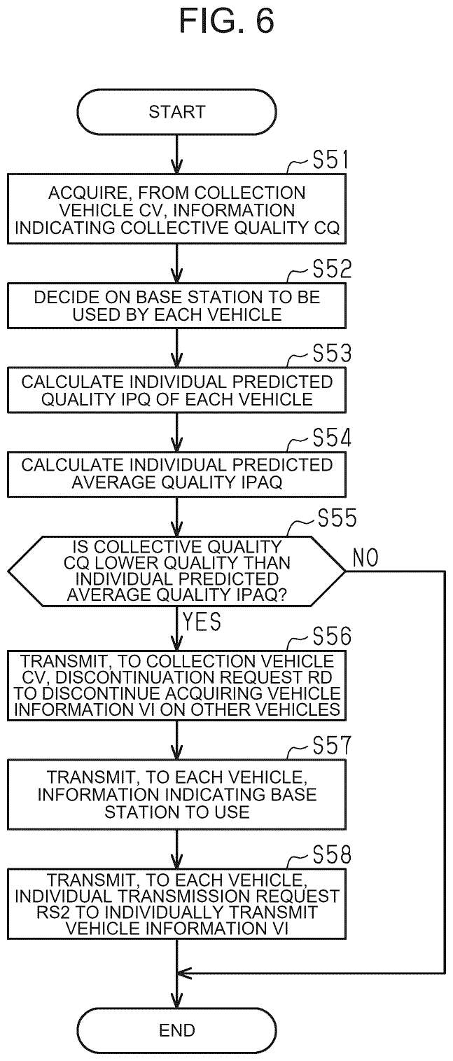

As shown in FIG. 6, when execution of the division program P4 for dividing vehicle information VI is started, the CPU 61 first performs a process in step S51. In step S51, the CPU 61 acquires, from the collection vehicle CV, information indicating a collective quality CQ that is a communication quality in collecting and transmitting vehicle information VI on all the vehicles 20 constituting the vehicle group. For example, the collective quality CQ is a transmission speed. Thereafter, the CPU 61 moves the process to step S52.

In step S52, the CPU 61 decides on a base station 30 to be used by each vehicle 20. Specifically, as the base station 30 to be used by a vehicle 20, the CPU 61 decides on a base station 30, among the plurality of base stations 30, that is the closest to a position indicated by position information included in the latest forecast information FI on the vehicle 20. Similarly, the base stations 30 to be used by the remaining four vehicles 20 are decided, respectively. Thereafter, the CPU 61 moves the process to step S53.

In step S53, the CPU 61 calculates an individual predicted quality IPQ of each vehicle 20. The individual predicted quality IPQ is a result of predicting a communication quality expected when a vehicle 20 individually transmits vehicle information VI to the server 40. Specifically, the CPU 61 assumes a case where a vehicle 20 transmits a preset data amount of vehicle information VI by using the base station 30 decided in step S52. The CPU 61 calculates a transmission speed expected when the data amount is transmitted by using the decided base station 30. Similarly, the CPU 61 calculates the individual predicted quality IPQ of each of the remaining four vehicles 20. Thereafter, the CPU 61 moves the process to step S54.

In step S54, the CPU 61 calculates an individual predicted average quality IPAQ. The individual predicted average quality IPAQ is an average quality of the individual predicted qualities IPQ. Specifically, as the individual predicted average quality IPAQ, the CPU 61 calculates an average value of the respective individual predicted qualities IPQ of the vehicles 20 acquired in step S53. Note that the individual predicted average quality IPAQ is a second predetermined quality in the first embodiment. Thereafter, the CPU 61 moves the process to step S55.

In step S55, the CPU 61 determines whether or not the collective quality CQ is a lower quality than the individual predicted average quality IPAQ. Specifically, the CPU 61 compares the transmission speed acquired as the collective quality CQ with a transmission speed calculated as the individual predicted average quality IPAQ. When the transmission speed acquired as the collective quality CQ is less than the transmission speed calculated as the individual predicted average quality IPAQ, the CPU 61 determines that the collective quality CQ is a lower quality than the individual predicted average quality IPAQ. When the transmission speed acquired as the collective quality CQ is equal to or more than the transmission speed calculated as the individual predicted average quality IPAQ, the CPU 61 determines that the collective quality CQ is not a lower quality than the individual predicted average quality IPAQ.

When the CPU 61 determines that the collective quality CQ is a lower quality than the individual predicted average quality IPAQ (S55: YES), the CPU 61 moves the process to step S56. In step S56, the CPU 61 transmits, to the collection vehicle CV, a discontinuation request RD to discontinue acquiring vehicle information VI on the other vehicles 20. Thereafter, the CPU 61 moves the process to step S57.

In step S57, the CPU 61 transmits, to each vehicle 20 in the vehicle group, information indicating a base station 30 to use that is decided in step S52. Thereafter, the CPU 61 moves the process to step S58.

In step S58, the CPU 61 transmits, to each vehicle 20 in the vehicle group, an individual transmission request RS2 to individually transmit vehicle information VI to the server 40. Note that a vehicle 20 that has received the transmission request discontinues transmitting vehicle information VI to the collection vehicle CV. Each vehicle 20 that has received the transmission request individually transmits vehicle information VI to the server 40. Thereafter, the CPU 61 terminates the current series of processes.

When the CPU 61 determines that the collective quality CQ is not a lower quality than the individual predicted average quality IPAQ (S55: NO), the CPU 61 terminates the current series of processes. In other words, in such a case, the CPU 61 terminates the series of processes, leaving the state as it is in which vehicle information VI on all the vehicles 20 constituting the vehicle group is collected and transmitted from the collection vehicle CV.

Flow of Information When State Is Turned from Collection-Transmission State into Individual Transmission State

Next, a description is given of a flow of information in the communication system 10 when a state is turned from a state where the collection vehicle CV collects and transmits vehicle information VI on the plurality of vehicle 20, into a state where the plurality of vehicles 20 individually transmits vehicle information VI.

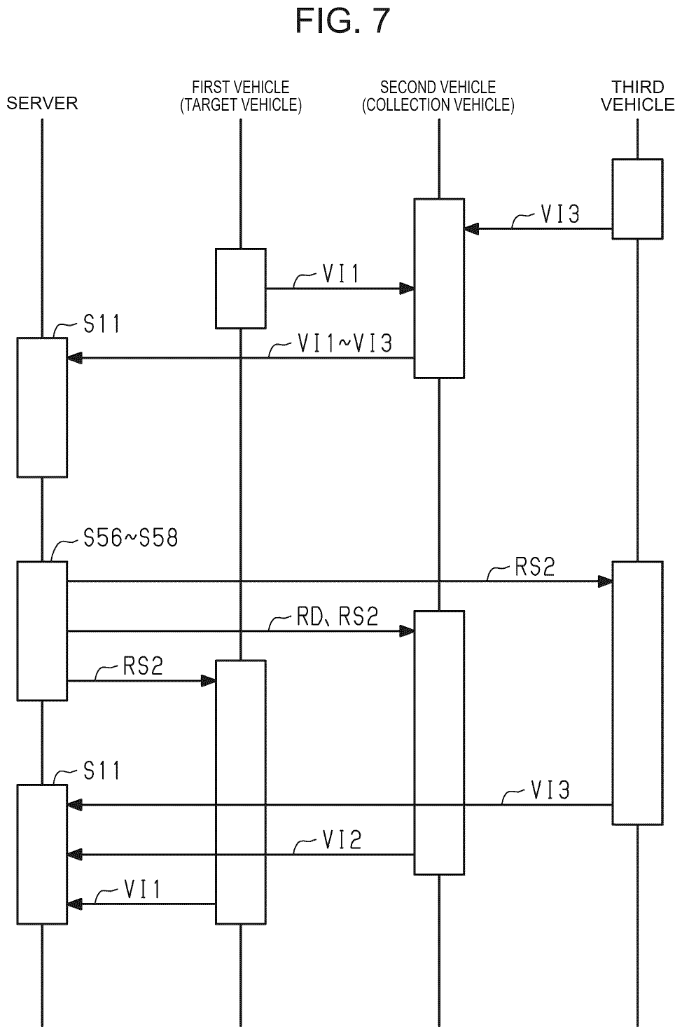

As shown in FIG. 7, the third vehicle transmits third vehicle information VI3 to the second vehicle. The first vehicle transmits first vehicle information VI1 to the second vehicle. The second vehicle collects and transmits the acquired first vehicle information VI1 and second vehicle information VI2, and the acquired third vehicle information VI3 to the server 40. The server 40 acquires the first vehicle information VI1, the second vehicle information VI2, and the third vehicle information VI3 through the process in step S11.

Subsequently, when the server 40 makes an affirmative determination in step S55 by executing the division program P4 for dividing vehicle information VI, the server 40 performs the processes in steps S56 to S58. Thus, the server 40 transmits an individual transmission request RS2 to the third vehicle. The third vehicle that has received the individual transmission request RS2 transmits third vehicle information VI3 to the server 40. The server 40 transmits a discontinuation request RD and an individual transmission request RS2 to the second vehicle. The second vehicle that has received the discontinuation request RD and the individual transmission request RS2 discontinues acquiring first vehicle information VI1 and third vehicle information VI3 and also transmits second vehicle information VI2 to the server 40. Moreover, the server 40 transmits an individual transmission request RS2 to the first vehicle. The first vehicle that has received the individual transmission request RS2 transmits first vehicle information VI1 to the server 40. The server 40 acquires the first vehicle information VI1, the second vehicle information VI2, and the third vehicle information VI3 individually from the vehicles 20, respectively, through the process in step S11.

### OPERATION OF FIRST EMBODIMENT

In the communication system 10, it is assumed that each vehicle 20 included in a vehicle group individually transmits vehicle information VI to the server 40. It is assumed that the communication qualities of vehicles 20 excluding a collection vehicle CV, of the five vehicles 20 constituting the vehicle group, have temporarily deteriorated due to the communication state of each vehicle 20. In such a case, in the server 40, the CPU 61 performs the series of processes shown in FIG. 4 by executing the collection program P3 for collecting vehicle information VI. In such a case, of the five vehicles 20, a vehicle 20 with the lowest individual quality IQ is the first vehicle, and the collection vehicle CV, which has the highest individual quality IQ, is the second vehicle. Accordingly, as shown in FIG. 5, the first vehicle and the third vehicle transmit vehicle information VI to the collection vehicle CV, without individually transmitting vehicle information VI to the server 40. The collection vehicle CV acquires a transmission request RS1 for collection and transmission and thus collects and transmits vehicle information VI on all the vehicles 20 constituting the vehicle group to the server 40.

### ADVANTAGEOUS EFFECTS OF FIRST EMBODIMENT

(1-1) According to the first embodiment, when communication quality deteriorates in a network constructed by a base station 30 for the first vehicle, the collection vehicle CV collects and transmits first vehicle information VI1 to the server 40. Accordingly, when the communication quality of the first vehicle is low, first vehicle information VI1 is transmitted via the collection vehicle CV, without the first vehicle directly transmitting vehicle information VI to the server 40. Thus, it is possible to reduce the likelihood of the server 40 being delayed in receiving first vehicle information VI1 due to deterioration of the communication quality of the first vehicle.

(1-2) According to the first embodiment, when it is determined that the individual quality IQ of the first vehicle is a lower quality than the collective predicted quality CPQ, the server 40 transmits an acquisition request RG to the second vehicle, which is the collection vehicle CV. Thus, the second vehicle can realize that the second vehicle will receive vehicle information VI on the other vehicles 20 including the first vehicle. As a result, even if the second vehicle has not acquired vehicle information VI on the other vehicles 20 before receiving the acquisition request RG, the second vehicle can start the process of acquiring vehicle information VI on the other vehicles 20 including the first vehicle at a timing when the acquisition request RG is acquired. Accordingly, the second vehicle does not need to acquire unnecessary vehicle information VI when the second vehicle does not collect and transmit vehicle information VI.

(1-3) According to the first embodiment, when it is determined that the

individual quality IQ of the first vehicle is a lower quality than the collective predicted quality CPQ, the server 40 transmits a collection request RC to the vehicles 20 including the first vehicle in the vehicle group, other than the second vehicle, which is the collection vehicle CV. Thus, the vehicles 20 other than the second vehicle can realize that the other vehicles 20 will transmit vehicle information VI to the collection vehicle CV.

(1-4) In the first embodiment, the server 40 generates forecast information FI, based on a plurality of pieces of acquired vehicle information VI. In generating forecast information FI, if some vehicle information VI cannot be acquired, it is difficult for the server 40 to generate forecast information FI with high accuracy. In this respect, according to the first embodiment, it is possible to reduce the likelihood of failure to acquire vehicle information VI due to deterioration in a communication situation for the first vehicle, and as a result, it is possible to reduce the likelihood of deterioration in the accuracy with which the server 40 generates forecast information FI.

(1-5) In the first embodiment, the server 40 determines, based on the forecast information FI, whether or not the first vehicle is traveling in a vehicle group. If the accuracy of the stored forecast information FI is low, it is difficult for the server 40 to appropriately determine whether or not the first vehicle is traveling in a vehicle group. In this respect, according to the first embodiment, it is possible to reduce the likelihood of deterioration in the accuracy of the forecast information FI in connection with deterioration in a communication situation for the first vehicle, and as a result, it is possible to reduce the likelihood of deterioration in the accuracy with which the server 40 determines whether or not the first vehicle is traveling in a vehicle group.

Then, a request is made that vehicle information VI on the first vehicle be transmitted from the second vehicle included in the vehicle group, whereby the second vehicle can implement receiving vehicle information VI on the first vehicle from the first vehicle through vehicle-to-vehicle communication.

(1-6) According to the first embodiment, the first predetermined quality is the collective predicted quality CPQ. Accordingly, by comparison with the communication quality expected if vehicle information VI is collected and transmitted, the CPU 61 can determine whether or not to collect vehicle information VI.

(1-7) According to the first embodiment, the server 40 determines a communication quality by using the individual average quality IAQ among a plurality of vehicles 20 including the first vehicle, the second vehicle, and the third vehicle. Specifically, the server 40 determines whether or not the individual average quality IAQ is a lower quality than the collective predicted quality CPQ. In such a case, even if the individual quality IQ of the third vehicle is a higher quality than the collective predicted quality CPQ, the CPU 61 transmits a transmission request RS1 to the collection vehicle CV such that vehicle information VI on all the vehicles 20 that constitute the vehicle group, including the third vehicle, will be transmitted from the collection vehicle CV. Thus, for one vehicle group in the communication system 10, the server 40 can bring about a situation in which all the vehicles 20 individually transmit vehicle information VI, or a situation in which one collection vehicle CV collects and transmits all vehicle information VI. Accordingly, the server 40 can relatively easily manage a transmission situation for the vehicle group.

(1-8) According to the first embodiment, the server 40, in a state of receiving first vehicle information VI1 from the second vehicle, which is the collection vehicle CV, determines whether or not the collective quality CQ is a lower quality than the individual predicted average quality IPAQ. When the server 40 determines that the collective quality CQ is a lower quality than the individual predicted average quality IPAQ, the server 40 transmits an individual transmission request RS2 to each vehicle 20 such that all the vehicles 20 constituting the vehicle group will individually transmit vehicle information VI. Thus, when a communication situation for the collection vehicle CV has deteriorated, the server 40 can prevent failure to receive all the vehicle information VI on the other vehicles 20.

### SECOND EMBODIMENT

Hereinafter, a second embodiment is described with reference to the drawings. In the second embodiment, processes are partially different in the collection program P3 for collecting vehicle information VI and the division program P4 for dividing vehicle information VI, compared to the first embodiment. Note that in the following, a description is focused on the different points from the first embodiment, and description of the same points is simplified or omitted.

The collection program P3 in the first embodiment is a program that determines whether or not to collect vehicle information VI on all the five vehicles 20. The division program P4 in the first embodiment is a program that determines whether or not to divide vehicle information VI on all the five vehicles 20. In contrast, a collection program P3 in the second embodiment is a program that determines whether or not to collect vehicle information VI on one or some vehicles 20 in a vehicle group. A division program P4 in the second embodiment is a program that determines whether or not to divide vehicle information VI on one or some vehicles 20 in a vehicle group. In the following description of the second embodiment, a first vehicle is a vehicle 20 subjected to the determination of whether or not to collect, or to divide, vehicle information VI.

### Determination of Whether or Not to Perform Collection and Transmission When Individual Transmission Is Being Performed

Collection of vehicle information VI performed by the information processing device 60 is described. Here, as an example, a state is described in which one vehicle group includes five vehicles 20 among a plurality of vehicles 20.

When the first vehicle, which is a specified vehicle 20 in the vehicle group, individually transmits vehicle information VI and the vehicle group includes a vehicle 20 that collects and transmits vehicle information VI, the CPU 61 executes the collection program P3 for collecting vehicle information VI in each preset predetermined period.

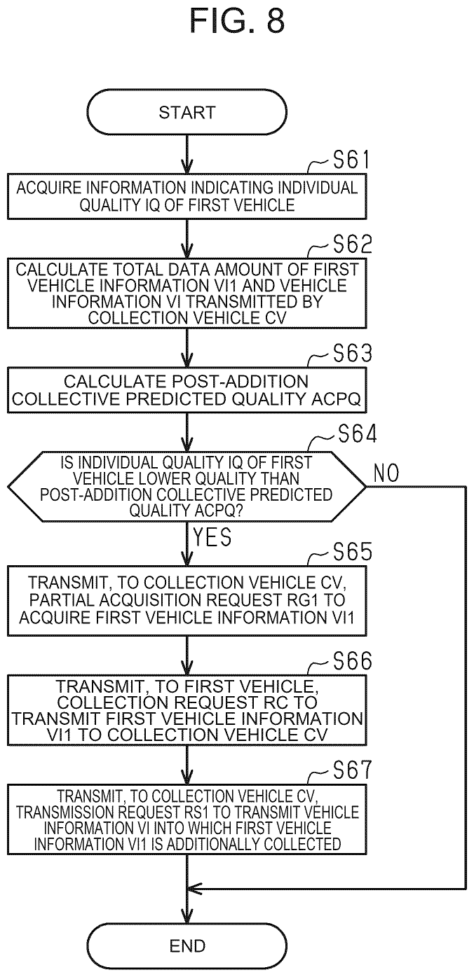

As shown in FIG. 8, when execution of the collection program P3 for collecting vehicle information VI in the second embodiment is started, the CPU 61 first performs a process in step S61. In step S61, the CPU 61 acquires, from the first vehicle, information indicating the individual quality IQ of the first vehicle. Thereafter, the CPU 61 moves the process to step S62.

In step S62, the CPU 61 calculates a total data amount of first vehicle information VI1 and vehicle information VI that is transmitted by the collection vehicle CV. Specifically, the CPU 61 calculates the total data amount by adding the data amount of the vehicle information VI that is collected and transmitted by the collection vehicle CV to the data amount of the first vehicle information VI1. Thereafter, the CPU 61 moves the process to step S63.

In step S63, the CPU 61 predicts, as a post-addition collective predicted quality ACPQ, a communication quality expected when the collection vehicle CV additionally collects and transmits first vehicle information VI1 to the server 40. Specifically, the CPU 61 calculates a communication quality in a case of transmitting the total data amount calculated in step S62, as the post-addition collective predicted quality ACPQ. Thereafter, the CPU 61 moves the process to step S64.

In step S64, the CPU 61 determines whether or not the individual quality IQ of the first vehicle is a lower quality than the post-addition collective predicted quality ACPQ. Specifically, the CPU 61 compares a transmission speed calculated as the individual quality IQ of the first vehicle with a transmission speed calculated as the post-addition collective predicted quality ACPQ. When the transmission speed calculated as the individual quality IQ of the first vehicle is less than the transmission speed calculated as the post-addition collective predicted quality ACPQ, the CPU 61 determines that the individual quality IQ of the first vehicle is a lower quality than the post-addition collective predicted quality ACPQ. When the transmission speed calculated as the individual quality IQ of the first vehicle is equal to or more than the transmission speed calculated as the post-addition collective predicted quality ACPQ, the CPU 61 determines that the individual quality IQ of the first vehicle is not a lower quality than the post-addition collective predicted quality ACPQ. Note that the post-addition collective predicted quality ACPQ is a first predetermined quality in the second embodiment.

When the CPU 61 determines that the individual quality IQ of the first vehicle is a lower quality than the post-addition collective predicted quality ACPQ (S64: YES), the CPU 61 moves the process to step S65. In step S65, the CPU 61 transmits, to the collection vehicle CV, a partial acquisition request RG1 to acquire first vehicle information VI1. Thereafter, the CPU 61 moves the process to step S66.

In step S66, the CPU 61 transmits, to the first vehicle, a collection request RC to transmit first vehicle information VI1 to the collection vehicle CV. Note that the first vehicle that has received the collection request transmits vehicle information VI to the collection vehicle CV and discontinues transmitting vehicle information VI to the server 40 without going through the collection vehicle CV. Thereafter, the CPU 61 moves the process to step S67.

In step S67, the CPU 61 transmits, to the collection vehicle CV, a transmission request RS1 to transmit vehicle information VI into which first vehicle information VI1 is additionally collected. In other words, the CPU 61 requests that the collection vehicle CV additionally collect and transmit first vehicle information VI1 in addition to vehicle information VI on the vehicles 20 that has been already collected. Thereafter, the CPU 61 terminates the current series of processes.

When the CPU 61 determines that the individual quality IQ of the first vehicle is not a lower quality than the post-addition collective predicted quality ACPQ (S64: NO), the CPU 61 terminates the current series of processes. In other words, in such a case, the CPU 61 terminates the series of processes, leaving the state as it is in which vehicle information VI is individually transmitted from the first vehicle, without first vehicle information VI1 being collected to the collection vehicle CV.

Flow of Information When State of First Vehicle Is Turned from Individual Transmission State into Collection-Transmission State

Next, a description is given of a flow of information when a state is turned from a state where the first vehicle individually transmits first vehicle information VIL and the second vehicle collects and transmits third vehicle information VI3, into a state where the second vehicle additionally collects and transmits also first vehicle information VI1.

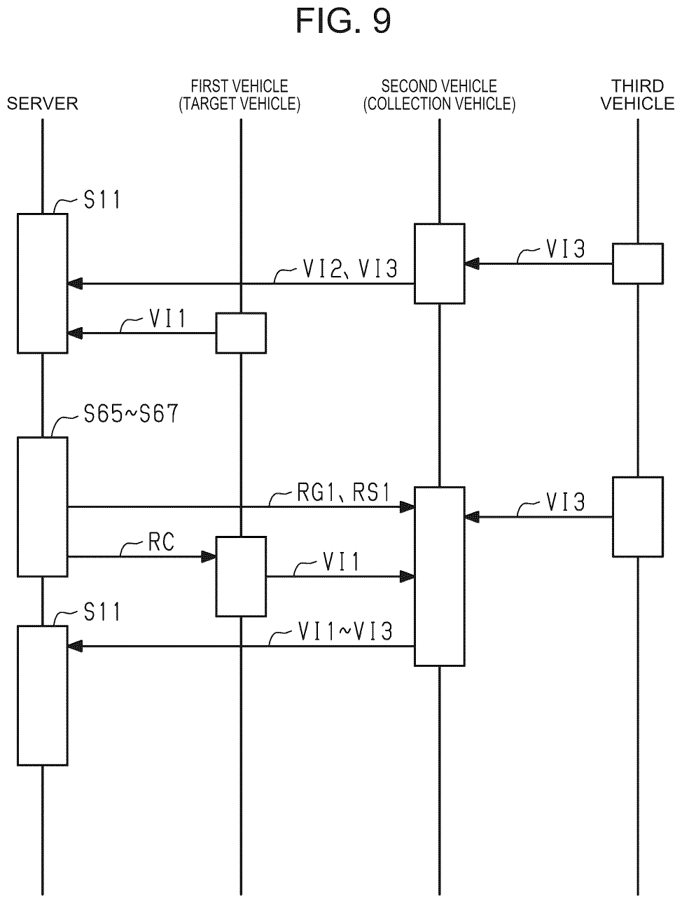

As shown in FIG. 9, the third vehicle transmits third vehicle information VI3 to the second vehicle. The second vehicle collects and transmits second vehicle information VI2 and the third vehicle information VI3 to the server 40. The first vehicle transmits first vehicle information VI1 to the server 40. The server 40 acquires the first vehicle information VI1 and the second vehicle information VI2, and the third vehicle information VI3 through the process in step S11.

Next, when the server 40 makes an affirmative determination in step S64 by executing the collection program P3 for collecting vehicle information VI, the server 40 performs the processes in steps S65 to S67. Thus, the server 40 transmits a collection request RC to the first vehicle. The first vehicle that has received the collection request RC transmits first vehicle information VI1 to the second vehicle. On the other hand, the server 40 does not transmit information to the third vehicle. Accordingly, the third vehicle continues transmitting third vehicle information VI3 to the second vehicle. The server 40 transmits a partial acquisition request RG1 and a transmission request RS1 to the second vehicle. The second vehicle that has received the partial acquisition request RG1 and the transmission request RS1 collects and transmits first vehicle information VI1, in addition to second vehicle information VI2 and third vehicle information VI3, to the server 40. The server 40 acquires the first vehicle information VI1, the second vehicle information VI2, and the third vehicle information VI3 from the second vehicle through the process in step S11.

### Determination of Whether or Not to Perform Individual Transmission When Collection-Transmission Is Being Performed

When vehicle information VI on the first vehicle, which is a specified vehicle 20 in the vehicle group, is collected and transmitted to the server 40 from the collection vehicle CV that is different from the first vehicle, the CPU 61 executes the division program P4 for dividing vehicle information VI in each present predetermined period.

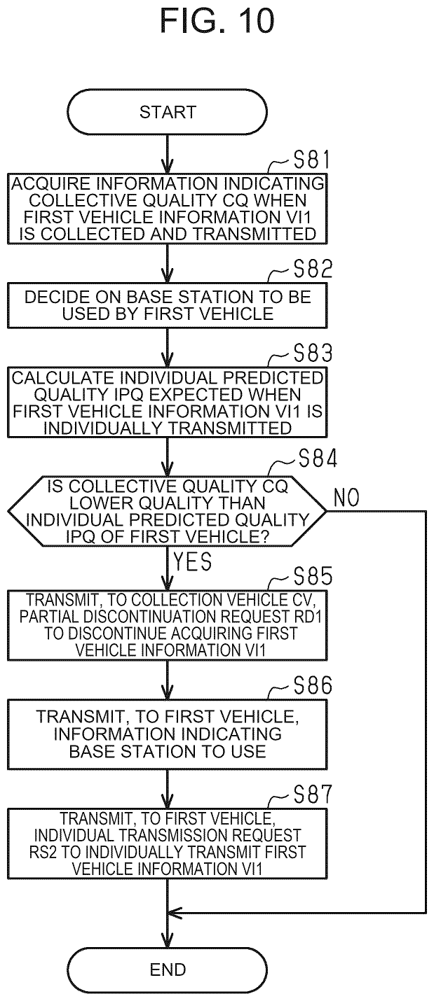

As shown in FIG. 10, when execution of the division program P4 for dividing vehicle information VI in the second embodiment is started, the CPU 61 first performs a process in step S81. In step S81, the CPU 61 acquires, from the collection vehicle CV, information indicating a collective quality CQ that is a communication quality when first vehicle information VI1 is collected and transmitted. Thereafter, the CPU 61 moves the process to step S82.

In step S82, the CPU 61 decides on a base station 30 to be used by the first vehicle. Specifically, as the base station 30 to be used by the first vehicle, the CPU 61 decides on a base station 30, among a plurality of base stations 30, that is the closest to a position indicated by position information included in the latest forecast information FI on the first vehicle. Thereafter, the CPU 61 moves the process to step S83.

In step S83, the CPU 61 calculates an individual predicted quality IPQ that is a result of predicting a communication quality expected when the first vehicle individually transmits first vehicle information VI1. Note that the individual predicted quality IPQ is a second predetermined quality in the second embodiment. Thereafter, the CPU 61 moves the process to step S84.

In step S84, the CPU 61 determines whether or not the collective quality CQ is a lower quality than the individual predicted quality IPQ of the first vehicle. Specifically, the CPU 61 compares a transmission speed acquired as the collective quality CQ with a transmission speed calculated as the individual predicted quality IPQ of the first vehicle. When the transmission speed acquired as the collective quality CQ is less than the transmission speed calculated as the individual predicted quality IPQ of the first vehicle, the CPU 61 determines that the collective quality CQ is a lower quality than the individual predicted quality IPQ of the first vehicle. When the transmission speed acquired as the collective quality CQ is equal to or more than the transmission speed calculated as the individual predicted quality IPQ of the first vehicle, the CPU 61 determines that the collective quality CQ is not a lower quality than the individual predicted quality IPQ of the first vehicle.

When the CPU 61 determines that the collective quality CQ is a lower quality than the individual predicted quality IPQ of the first vehicle (S84: YES), the CPU 61 moves the process to step S85. In step S85, the CPU 61 transmits, to the collection vehicle CV, a partial discontinuation request RD1 to discontinue acquiring first vehicle information VI1. Thereafter, the CPU 61 moves the process to step S86.

In step S86, the CPU 61 transmits, to the first vehicle, information indicating the base station to be used by the first vehicle that is decided in step S82. Thereafter, the CPU 61 moves the process to step S87.

In step S87, the CPU 61 transmits, to the first vehicle, an individual transmission request RS2 to individually transmit vehicle information VI to the server 40. Note that the first vehicle that has received the transmission request discontinues transmitting vehicle information VI to the collection vehicle CV. Thereafter, the CPU 61 terminates the current series of processes.

When the CPU 61 determines that the collective quality CQ is not a lower quality than the individual predicted quality IPQ of the first vehicle (S84: NO), the CPU 61 terminates the current series of processes. In other words, in such a case, the CPU 61 terminates the series of processes, leaving the state as it is in which first vehicle information VI1 is collected and transmitted from the collection vehicle CV.

Flow of Information When State Is Turned from Collection-Transmission State into Individual Transmission State

Next, a description is given of a flow of information in the communication system 10 when a state is turned from a state where the collection vehicle CV collects and transmits vehicle information VI on a plurality of vehicles 20, into a state where only the first vehicle individually transmits vehicle information VI.

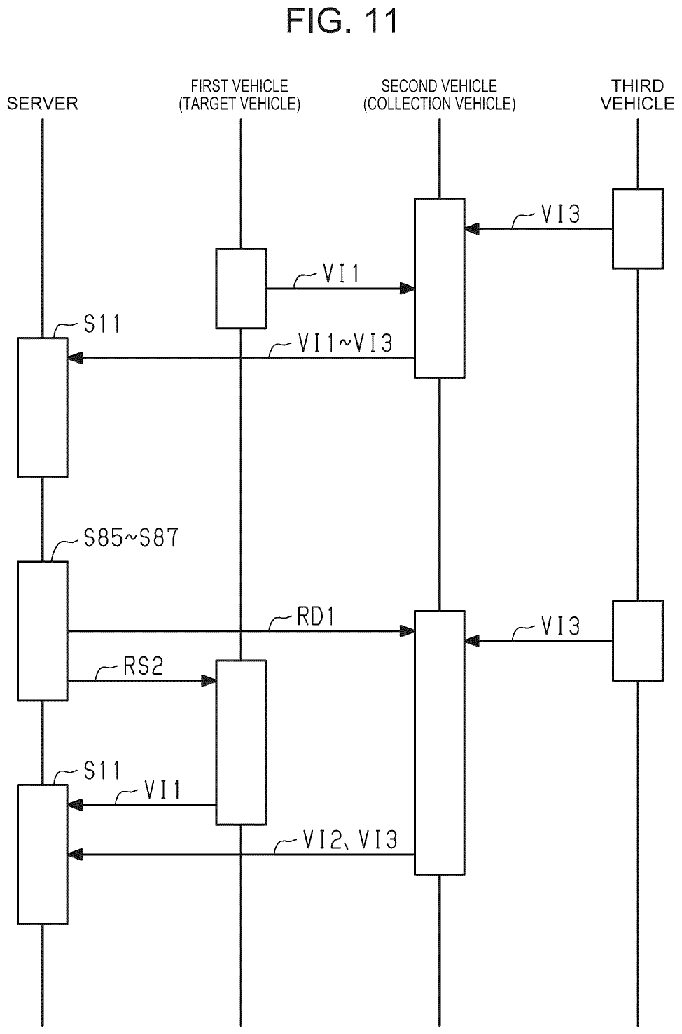

As shown in FIG. 11, the third vehicle transmits third vehicle information VI3 to the second vehicle. The first vehicle transmits first vehicle information VI1 to the second vehicle. The second vehicle collects and transmits the acquired first vehicle information VI1 and second vehicle information VI2, and the acquired third vehicle information VI3 to the server 40. The server 40 acquires the first vehicle information VI1, the second vehicle information VI2, and the third vehicle information VI3 through the process in step S11.

Next, when the server 40 makes an affirmative determination in step S84 by executing the division program P4 for dividing vehicle information VI, the server 40 performs the processes in steps S85 to S87. Thus, the server 40 transmits an individual transmission request RS2 to the first vehicle. The first vehicle that has received the individual transmission request RS2 transmits first vehicle information VI1 to the server 40. On the other hand, the server 40 does not transmit an individual transmission request RS2 to the third vehicle. Accordingly, the third vehicle continues transmitting third vehicle information VI3 to the second vehicle. The server 40 transmits a partial discontinuation request RD1 to the second vehicle. The second vehicle that has received the partial discontinuation request RD1 discontinues acquiring first vehicle information VI1 and transmits second vehicle information VI2 and third vehicle information VI3 to the server 40.

In other words, the second vehicle collects and transmits second vehicle information VI2 and third vehicle information VI3, without collecting only first vehicle information VI1. The server 40 acquires the first vehicle information VI1, the second vehicle information VI2, and the third vehicle information VI3 through the process in step S11.

### OPERATION OF SECOND EMBODIMENT

In the communication system 10, a situation is assumed in which, of the vehicles 20 included in a vehicle group, the first vehicle individually transmits vehicle information VI to the server 40 and the other vehicles 20 collect vehicle information VI to the collection vehicle CV. For example, such a situation applies to a case where the first vehicle newly joins a vehicle group including a collection vehicle CV, and the like. In such a case, in the server 40, the CPU 61 performs the series of processes shown in FIG. 6 by executing the collection program P3 for collecting vehicle information VI in the second embodiment. When the individual quality IQ of the first vehicle is a lower quality than the post-addition collective predicted quality ACPQ, the first vehicle transmits vehicle information VI to the collection vehicle CV, without individually transmitting vehicle information VI to the server 40. The collection vehicle CV additionally collects and transmits also first vehicle information VI1 to the server 40.

### ADVANTAGEOUS EFFECTS OF SECOND EMBODIMENT

According to the second embodiment, advantageous effects as described below can be brought about, in addition to the advantageous effects (1-1) to (1-6) and (1-8) of the first embodiment.

(2-1) According to the second embodiment, the server 40 determines

whether or not to additionally collect first vehicle information VI1, by comparing the individual quality IQ of the first vehicle with the post-addition collective predicted quality ACPQ. In other words, with regard to each vehicle 20, the server 40 determines whether or not to additionally collect vehicle information VI, by comparison with a communication quality expected if the vehicle information VI is additionally collected. Accordingly, the server 40 can achieve a high communication quality in the state of transmission of vehicle information VI on a plurality of vehicles 20 in the communication system 10, in a case where first vehicle information VI1 is added or in a case where first vehicle information VI1 is not added.

(2-2) According to the second embodiment, the server 40, in a state of receiving first vehicle information VI1 from the second vehicle, which is the collection vehicle CV, determines whether or not the individual predicted quality IPQ of the first vehicle is a lower quality than the collective quality CQ. When the server 40 determines that the collective quality CQ is a lower quality than the individual predicted quality IPQ, the server 40 transmits an individual transmission request RS2 to the first vehicle such that the first vehicle, among the vehicles 20 constituting a vehicle group, individually transmits first vehicle information VI1. Thus, when a communication situation for the first vehicle has deteriorated, the server 40 can change only the communication path of first vehicle information VI1 from the first vehicle, without changing communication of the third vehicle.

### THIRD EMBODIMENT

Hereinafter, a third embodiment is described with reference to the drawings. In the third embodiment, processes are partially different in the collection program P3 for collecting vehicle information VI, compared to the second embodiment. Note that in the following, a description is focused on the different points from the second embodiment, and description of the same points is simplified or omitted.

The first predetermined quality in the first embodiment is the collective predicted quality CPQ. The first predetermined quality in the second embodiment is the post-addition collective predicted quality ACPQ. Both of the first predetermined qualities are calculated in a series of processes. In contrast, a predetermined quality RQ in the third embodiment is a preset quality.

### Determination of Whether or Not to Perform Collection and Transmission When Individual Transmission Is Being Performed

Collection of vehicle information VI performed by the information processing device 60 is described. Here, as an example, a state is described in which one vehicle group includes five vehicles 20 among a plurality of vehicles 20.

When the first vehicle, which is a specified vehicle 20 in the vehicle group, individually transmits vehicle information VI and the vehicle group includes a vehicle 20 that collects and transmits vehicle information VI, the CPU 61 executes the collection program P3 for collecting vehicle information VI in each preset predetermined period.

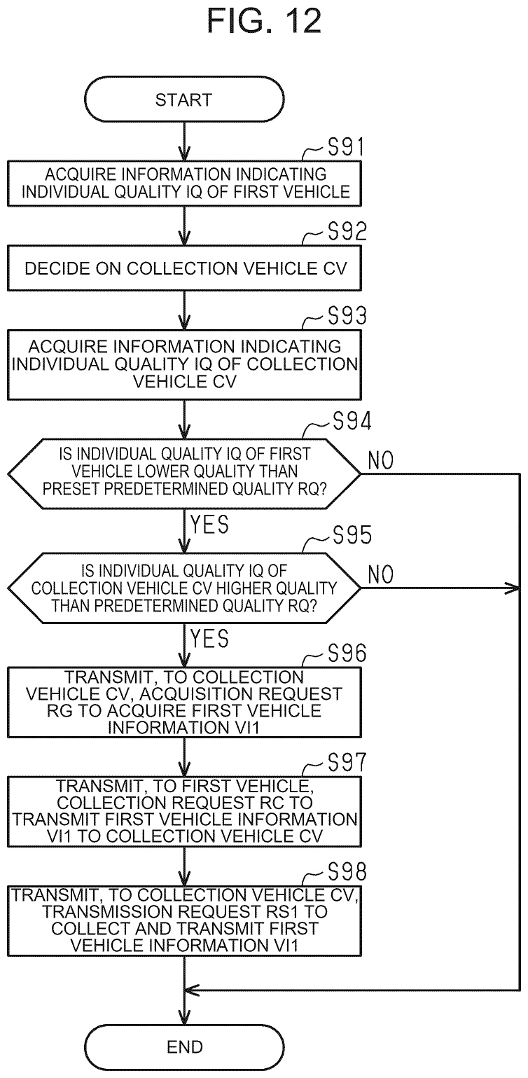

As shown in FIG. 12, when execution of the collection program P3 for collecting vehicle information VI in the third embodiment is started, the CPU 61 first performs a process in step S91. In step S91, the CPU 61 acquires, from the first vehicle, information indicating the individual quality IQ of the first vehicle. Thereafter, the CPU 61 moves the process to step S92.

In step S92, the CPU 61 decides on a collection vehicle CV that is different from the first vehicle, from among a plurality of vehicles 20. From among the vehicles 20 that constitute the vehicle group including the first vehicle, the CPU 61 decides on, as the collection vehicle CV, one of the vehicles 20 that are different from the first vehicle. Thereafter, the CPU 61 moves the process to step S93.

In step S93, the CPU 61 acquires, from the collection vehicle CV, information indicating the individual quality IQ of the collection vehicle CV. Thereafter, the CPU 61 moves the process to step S94.

In step S94, the CPU 61 determines whether or not the individual quality IQ of the first vehicle is a lower quality than a preset predetermined quality RQ. The predetermined quality RQ is set through testing or simulation beforehand as a lower limit value of transmission speed at which vehicle information VI can be received without delay. Specifically, the CPU 61 compares a transmission speed that is the individual quality IQ of the first vehicle acquired in step S91, with a transmission speed that is the predetermined quality RQ. When the transmission speed that is the individual quality IQ of the first vehicle is less than the transmission speed that is the predetermined quality RQ, the CPU 61 determines that the individual quality IQ of the first vehicle is a lower quality than the predetermined quality RQ. When the transmission speed that is the individual quality IQ of the first vehicle is equal to or more than the transmission speed that is the predetermined quality RQ, the CPU 61 determines that the individual quality IQ of the first vehicle is not a lower quality than the predetermined quality RQ.

When the CPU 61 determines that the individual quality IQ of the first vehicle is a lower quality than the predetermined quality RQ (S94: YES), the CPU 61 moves the process to step S95. In step S95, the CPU 61 determines whether or not the individual quality IQ of the collection vehicle CV is a higher quality than the predetermined quality RQ. Specifically, the CPU 61 compares a transmission speed that is the individual quality IQ of the collection vehicle CV acquired in step S93, with the transmission speed that is the predetermined quality RQ. When the transmission speed that is the individual quality IQ of the collection vehicle CV is more than the transmission speed that is the predetermined quality RQ, the CPU 61 determines that the individual quality IQ of the collection vehicle CV is a higher quality than the predetermined quality RQ. When the transmission speed that is the individual quality IQ of the collection vehicle CV is equal to or less than the transmission speed that is the predetermined quality RQ, the CPU 61 determines that the individual quality IQ of the collection vehicle CV is not a higher quality than the predetermined quality RQ.

When the CPU 61 determines that the individual quality IQ of the collection vehicle CV is a higher quality than the predetermined quality RQ (S95: YES), the CPU 61 moves the process to step S96. In step S96, the CPU 61 transmits, to the collection vehicle CV, an acquisition request RG to acquire first vehicle information VI1. Thereafter, the CPU 61 moves the process to step S97.

In step S97, the CPU 61 transmits, to the first vehicle, a collection request RC to transmit vehicle information VI to the collection vehicle CV. Thereafter, the CPU 61 moves the process to step S98.

In step S98, the CPU 61 transmits, to the collection vehicle CV, a transmission request RS1 to transmit collected first vehicle information VI1. Thereafter, the CPU 61 terminates the series of processes.

When the CPU 61 determines that the individual quality IQ of the first vehicle is not a lower quality than the predetermined quality RQ (S94: NO), the CPU 61 terminates the current series of processes. In other words, in such a case, the CPU 61 terminates the series of processes, leaving the state as it is in which vehicle information VI is transmitted from the first vehicle and the second vehicle individually, without first vehicle information VI1 being collected to the collection vehicle CV.

When the CPU 61 determines that the individual quality IQ of the collection vehicle CV is not a higher quality than the predetermined quality RQ (S95: NO), the CPU 61 terminates the current series of processes. In other words, in such a case, the CPU 61 terminates the series of processes, leaving the state as it is in which vehicle information VI is transmitted from the first vehicle and the second vehicle individually, without first vehicle information VI1 being collected to the collection vehicle CV. In other words, in the third embodiment, the CPU 61 transmits a transmission request RS1 to the second vehicle, on condition that the individual quality IQ of the first vehicle is a lower quality than the predetermined quality RQ and also that the individual quality IQ of the second vehicle is a higher quality than the predetermined quality RQ.

### ADVANTAGEOUS EFFECTS OF THIRD EMBODIMENT

According to the third embodiment, advantageous effects as described below can be brought about, in addition to the advantageous effects (1-1) to (1-5) of the first embodiment and the advantageous effect (2-2) of the second embodiment.

(3-1) According to the third embodiment, the server 40 stores the preset predetermined quality RQ. The server 40 determines whether or not to collect first vehicle information VI1, by comparing the individual quality IQ of the first vehicle with the predetermined quality RQ. Accordingly, the server 40 does not need to calculate a communication quality for comparison each time determination is performed.

(3-2) According to the third embodiment, the server 40 determines whether or not to collect first vehicle information VI1, by comparing the collective quality CQ of the collection vehicle CV with the predetermined quality RQ. Accordingly, when the collective quality CQ of the collection vehicle CV is a lower quality, the server 40 does not additionally collect first vehicle information VI1 and thereby can prevent the communication situation from further deteriorating. Note that in the first and second embodiments, the first predetermined quality is configured to be an average quality and the second vehicle is configured to be a vehicle 20 with the highest communication quality, whereby similar effects are brought about.

### OTHER EMBODIMENTS

Each of the embodiments can be implemented with changes made as described below. Each of the embodiments and each modification described below can be implemented by being combined with each other to such an extent that no technical contradiction occurs.

### Information Processing Device

The information processing device 60 may be configured as circuitry including one or more processors that perform various processes in accordance with a computer program (software). Note that the information processing device 60 may be configured as one or more dedicated hardware circuits that perform at least one or some processes of the various processes, such as an application specific integrated circuit (ASIC), or circuitry including a combination of such hardware circuits. The processor includes a CPU and memory, such as a RAM and a ROM. The memory stores program codes or commands configured to cause the CPU to perform the processes. The memory, that is, computer-readable media include every accessible medium that can be accessed by a general-purpose or dedicated computer. In this respect, the same applies to the vehicle control device 22.

### Forecast Information

When generating forecast information FI, the information processing device 60 may set the reference time to another time. For example, the CPU 61 may set, as the reference time, a future time that is later than the time of acquisition of vehicle information VI that has the latest time of acquisition. In such a case, the information processing device 60 can control a vehicle 20 and the like, based on position information or the like on the vehicle 20 at the future time, by using the forecast information FI.

For forecast information FI, the information processing device 60 may store information in which a plurality of pieces of vehicle information VI is not in synchronization. Even if the plurality of pieces of vehicle information VI is not in synchronization, the information processing device 60 can perform determination of a vehicle group, based on a difference between times of acquisition of the plurality of pieces of vehicle information VI.

The information processing device 60 may store only the latest forecast information FI in the data center 70. For example, the data center 70 may delete past forecast information FI when new forecast information FI is acquired.

The manner in which the information processing device 60 generates forecast information FI is not limited to the example in the first embodiment. For example, when vehicle information VI includes information indicating a scheduled route of traveling, the CPU 61 may generate a position of a vehicle 20 as forecast information FI, based on the scheduled route of traveling.

The information processing device 60 may omit to generate forecast information FI. For example, another device that is different from the information processing device 60 may generate forecast information FI. Moreover, for example, the information processing device 60 may use acquired vehicle information VI to control a plurality of vehicles 20.

### Determination of Vehicle Group

The manner in which the information processing device 60 determines a vehicle group is not limited to the example in the first embodiment. For example, the CPU 61 may determine whether or not vehicles 20 constitute a vehicle group, by predicting future positions thereof, based on forecast information FI.

For example, when vehicle information VI includes information indicating that a vehicle 20 is following another vehicle 20, the CPU 61 may determine, based on the information indicating the following, that the vehicle 20, with the other vehicle 20, constitutes a vehicle group.

For example, when a preset route is traveled, the CPU 61 may determine that a plurality of vehicles 20 constitutes a vehicle group. Specifically, when vehicles 20 are traveling on a specific road, such as a freeway, the CPU 61 may determine, based on forecast information FI, that among a plurality of vehicles 20 within a certain range, vehicles 20 constitute a vehicle group if a difference in vehicle speed between the vehicles 20 is smaller than a predetermined difference. For example, the CPU 61 may determine that a vehicle 20 traveling at a higher speed constitutes a vehicle group with another vehicle 20 even if the distance from the other vehicle 20 is large.

With regard to not every vehicle 20, the information processing device 60 needs to determine whether or not a vehicle group is constituted. For example, only with regard to vehicles 20 traveling at higher speeds than a predetermined vehicle speed, the information processing device 60 may determine whether or not a vehicle group is constituted. It is possible to reduce acquisitions of vehicle information VI, with regard to a vehicle 20 with a large travel amount per unit time.

### Determination of Whether or Not to Perform Collection and Transmission

The information processing device 60 may start executing the collection program P3, regardless of whether or not the first vehicle and the second vehicle are traveling in a vehicle group. In such a case, for example, in the third embodiment, the information processing device 60 may decide on, as the collection vehicle CV, the second vehicle that is at a fairly close distance from the first vehicle.

The communication quality is not limited to the transmission speed. The communication quality may be a parameter that is determined based on the transmission speed. For a value indicating the communication quality, a value may be used that takes reliability, jitter, packet loss, quality of service (QOS), or communication delay time into account. The packet loss is a value indicating the proportion of lost packets to a transmitted volume. The communication quality may be determined based on the transmission speed, the packet loss, and the communication delay time. In such a case, it is easier for the information processing device 60 to determine that a situation requires that a delay in acquisition of vehicle information VI by the server 40 be reduced, or a situation is that the server 40 cannot acquire vehicle information VI.

In the first embodiment, the manner in which the information processing device 60 decides on a base station 30 is not limited to the example in each of the embodiments. For example, among available base stations 30, the CPU 61 may decide on a base station 30 that is being used by a smaller number of vehicles 20, based on the position of each vehicle 20. In such a case, when the communication situation of a base station 30 to be used is deteriorating due to an excessive number of vehicles 20, it is possible to avoid selecting the base station 30 of which the communication situation is deteriorating. In this respect, the same applies to step S52 when individual transmission is performed and step S82 in the second embodiment.

For example, the CPU 61 may decide on a base station 30, based on an indicator of each base station 30, such as the received signal strength of radio waves, the received electric power of a reference signal, the reception quality of the reference signal, or a signal-to-noise ratio.

In the first embodiment, in the process in step S34, the total data amount of vehicle information VI may be calculated as the number of data pieces of vehicle information VI.

In the first embodiment, the CPU 61 may perform the processes in steps S38 to S41 in changed order. In the second embodiment, the CPU 61 may perform the processes in steps S65 to S67 in changed order. In the third embodiment, the CPU 61 may perform the processes in steps S96 to S98 in changed order.

In the first embodiment, the information processing device 60 may omit to transmit information indicating a base station 30. The information processing device 60 may omit to decide on a base station 30. Specifically, the CPU 61 may omit the processes in steps S33 and S40. Each vehicle 20 may select and use a base station 30.

The information processing device 60 may omit to transmit a collection request RC. Specifically, the CPU 61 may omit the process in step S39 in the first embodiment, the process in step S66 in the second embodiment, or the process in step S97 in the third embodiment. For example, even in a case where a vehicle 20 does not receive a collection request RC from the server 40, the collection vehicle CV may transmit a request for vehicle information VI to a vehicle 20, and the vehicle 20 that has received the request may transmit vehicle information VI to the collection vehicle CV.

The information processing device 60 may omit to transmit an acquisition request RG. Specifically, the CPU 61 may omit the process in step S38 in the first embodiment, the process in step S65 in the second embodiment, or the process in step S96 in the third embodiment. For example, even in a case where the collection vehicle CV does not receive an acquisition request RG from the server 40, the collection vehicle CV may transmit a request to another vehicle 20 in order to acquire vehicle information VI when the collection vehicle CV, after receiving a transmission request RS1, fails to acquire vehicle information VI from the other vehicle 20. For example, the collection vehicle CV may acquire vehicle information VI on another vehicle 20, regardless of an acquisition request RG.

### Determination of Whether or Not to Perform Individual Transmission

In the first embodiment, the CPU 61 may perform the processes in steps S56 to S58 in changed order. In the second embodiment, the CPU 61 may perform the processes in steps S85 to S87 in changed order.

In each embodiment, the information processing device 60 may omit to transmit information indicating a base station 30. The information processing device 60 may omit to decide on a base station 30. Specifically, the CPU 61 may omit the processes in steps S52 and S57 in the first embodiment, or the processes in steps S82 and S86 in the second embodiment. Each vehicle 20 may select and use a base station 30.

The information processing device 60 may omit to transmit a discontinuation request RD or a partial discontinuation request RD1. Specifically, the CPU 61 may omit the process in step S56 in the first embodiment, or the process in step S85 in the second embodiment. In such a case, for example, when the first vehicle receives an individual transmission request RS2, the first vehicle may transmit, to the transmit collection vehicle CV, a signal indicating that transmission of first vehicle information VI1 is discontinued.

The second predetermined quality may be a preset communication quality. For example, when the number of pieces of vehicle information VI transmitted from one vehicle 20 exceeds a predetermined number, a discontinuation request RD may be transmitted.

The information processing device 60 may omit to execute the division program P4. For example, when the collection vehicle CV ceases to be included in a vehicle group, the CPU 61 may transmit an individual transmission request RS2 to all the vehicles 20 included in the vehicle group. For example, when the collection vehicle CV ceases to be included in a vehicle group, the CPU 61 may decide on, as a new collection vehicle CV, a vehicle 20 that has the second highest communication quality among the plurality of vehicles 20 included in the vehicle group. In such a case, the CPU 61 may transmit a transmission request RS1 and an acquisition request RG to the decided new collection vehicle CV, and may transmit a collection request RC to the other vehicles 20.

### Others

In respect of transmission of each request in each of the embodiments, the CPU 61 may transmit information indicating each request. For example, the information indicating a request may be information indicating a communication mode, and the transmission of each request may include making each request in order to bring about a communication mode indicated by such information. Moreover, for example, an individual transmission request RS2 may be a request to cancel a transmission request RS1 for collection and transmission. In other words, the information indicating a request is not only a signal indicating merely a request, but may indicate that a request is made, even without including a signal indicating the request itself.

The data amount of vehicle information VI may differ from vehicle 20 to vehicle 20.

The information acquisition device 23 is not limited to the example in each of the embodiments. For example, the information acquisition device 23 may be a sensor that acquires a steering angle, a sensor that acquires an accelerator operation amount, a device that acquires information indicating a destination of a vehicle 20, or the like.

In each of the embodiments, a description is given, assuming that the collection program P3 and the division program P4 are two programs. However, the collection program P3 and the division program P4 may be configured as one program. In this respect, the same applies to the generation program P1 for generating forecast information FI and the determination program P2 for determining a vehicle group, and the four programs may be configured as one program.

The combination of the collection program P3 and the division program P4 in each embodiment may be changed. For example, the CPU 61 may execute the collection program P3 in the first embodiment and the division program P4 in the second embodiment in combination.

### Supplementary Information

Technical ideas that can be conceived from each of the embodiments and the modifications are described.

What is claimed is:

1. A server configured to communicate with a first vehicle and a second vehicle, wherein when determination is made that a communication quality with the first vehicle is lower than a predetermined quality, the server is configured to transmit, to the second vehicle, information indicating a request of transmitting vehicle information of the first vehicle from the second vehicle.

2. The server according to claim 1, wherein when determination is made that the communication quality with the first vehicle is lower than the predetermined quality, the server is configured to transmit, to the second vehicle, information indicating a request of acquiring the vehicle information of the first vehicle.

3. The server according to claim 1, wherein when determination is made that the communication quality with the first vehicle is lower than the predetermined quality, the server is configured to transmit, to the first vehicle, information indicating a request of transmitting the vehicle information of the first vehicle to the second vehicle.

4. The server according to claim 1, wherein the server is configured to:
generate forecast information based on the vehicle information of the first vehicle and vehicle information of the second vehicle that are acquired, the forecast information being vehicle information of the first vehicle and vehicle information of the second vehicle in a predetermined area at a reference time after an acquisition time of the vehicle information of the first vehicle and vehicle information of the second vehicle; and
store the forecast information.

5. The server according to claim 4, wherein the server is configured to:
determine, based on the forecast information, whether the first vehicle is traveling in a vehicle group including the second vehicle; and
when determination is made that the first vehicle is traveling in the vehicle group and that the communication quality with the first vehicle is lower than the predetermined quality, transmit, to the second vehicle, the information indicating the request of transmitting the vehicle information of the first vehicle from the second vehicle.

6. The server according to claim 1, wherein the predetermined quality is a communication quality predicted when the vehicle information of the first vehicle and vehicle information of the second vehicle are transmitted from the second vehicle.

7. The server according to claim 1, wherein:
the server is configured to communicate with a third vehicle,
the predetermined quality is a communication quality predicted when vehicle information of a plurality of vehicles including the first vehicle, the second vehicle, and the third vehicle is transmitted from the second vehicle, and
the server is configured to:
determine that the communication quality with the first vehicle is lower than the predetermined quality when an average communication quality of communication qualities with the plurality of vehicles is lower than the predetermined quality; and
when determination is made that the communication quality with the first vehicle is lower than the predetermined quality, transmit information indicating a request of transmitting the vehicle information of the plurality of vehicles from the second vehicle even when a communication quality with the third vehicle is higher than the predetermined quality.

8. The server according to claim 1, wherein assuming that the predetermined quality is a first predetermined quality, when determination is made that a communication quality with the second vehicle is lower than a second predetermined quality in a state where the vehicle information of the first vehicle is received from the second vehicle, the server is configured to:
transmit, to the second vehicle, information indicating of discontinuation of transmitting the vehicle information of the first vehicle; and
transmit, to the first vehicle, information indicating a request of transmitting the vehicle information of the first vehicle.

9. The server according to claim 1, wherein the communication quality is a parameter determined based on at least one of a transmission speed, a packet loss, and a communication delay time.

10. A communication system comprising:
a first vehicle;
a second vehicle; and
a server configured to communicate with the first vehicle and the second vehicle, wherein
when determination is made that a communication quality with the first vehicle is lower than a predetermined quality, the server is configured to transmit, to the second vehicle, information indicating a request of transmitting vehicle information of the first vehicle from the second vehicle, and
when the information indicating the request of transmitting vehicle information of the first vehicle from the second vehicle is received, the second vehicle is configured to transmit the vehicle information of the first vehicle to the server.

11. A vehicle, wherein the vehicle is configured to:
when determination is made, by a server, that a communication quality with a target vehicle is lower than a predetermined quality, receive information indicating a request of collecting and transmitting vehicle information of the target vehicle to the server; and
when the information indicating the request of transmitting the vehicle information of the target vehicle to the server is received, transmit the vehicle information of the target vehicle to the server.
